(19) United States
(12) Patent Application Publication
(10) Pub. No.: US 2016/0050971 A1
(43) Pub. Date: Feb. 25, 2016

(54) CIGARETTE ROLLING PAPERS

(71) Applicant: SUSTAINABLE TRADING LIMITED, Maidstone (GB)

(72) Inventor: Jonathon Mark Harrison, Tenderton (GB)

(21) Appl. No.: 14/784,949

(22) PCT Filed: Apr. 16, 2014
(86) PCT No.: PCT/GB2014/051200

§ 371 Date: Oct. 15, 2015

(30) Foreign Application Priority Data
Apr. 16, 2013 (GB) 1306876.2

(51) Int. Cl. A24D 1/02; B32B 7/06; B32B 7/12; B32B 29/00

(52) U.S. Cl. CPC A24D 1/022; B32B 29/005; B32B 7/06; B32B 7/12; B32B 2255/12; B32B 2554/00

(57) ABSTRACT

A rectangular cigarette rolling paper (1) suitable for use in forming a self-rolled cigarette, comprises a repositionable pressure sensitive adhesive which is coated onto the bottom side of the paper (5) and is suitable for adhering said portion of the bottom side to the top side of the cigarette paper when the paper is formed into a cigarette by rolling the paper around tobacco. The sticky area comprises a plurality of regions (4) consisting of said repositionable pressure sensitive adhesive coated onto the bottom side of the paper and at least one region 6 where the bottom side of the paper is not coated with pressure sensitive adhesive. A plurality of the cigarette rolling papers may be assembled to form a pad of cigarette rolling papers.

### FIELD OF INVENTION

The present invention is concerned with cigarette rolling papers and pads of cigarette rolling papers. More particularly, the present invention is directed to cigarette rolling papers and pads of cigarette rolling papers for use in making self-rolled cigarettes.

### BACKGROUND OF THE INVENTION

Conventional rolling papers that are used to make self-rolled cigarettes are usually sold in packets of folded and interleaved oblong-shaped cigarette paper sheets, wherein one marginal edge of one of the two sides of each sheet is provided with an adhesive, such as a remoistenable gum e.g. gum arabica, to seal the cigarette after it has been rolled. Such rolling papers are normally cut from paper sheets having a weight in the range of from 5 to 40 gm⁻².

GB-A-2318992 discloses an oblong-shaped cigarette rolling paper, intended to be sold in packets of conventionally folded and interleaved sheets, having one of the longer marginal edges and one of the shorter marginal edges on one of the two sides of the paper provided with a gum.

Apparatuses for folding and interleaving continuously moving strips of paper and cutting the interleaved strips into packets of folded and interleaved paper sheets are well known. For example, U.S. Pat. No. 4,290,592 describes such apparatus wherein a supply roll of paper strip is provided for each sheet of paper in a packet, and the strips are simultaneously drawn from the supply rolls and though a series of formers and interleavers to provide a continuously moving strand of interleaved paper strips. The packets are then cut from the continuously moving strand of interleaved paper strips by severing means that moves along with the strand during cutting.

Apparatuses for making packets of folded interleaved cigarette rolling papers tend to be customised pieces of machinery, being unsuitable for making anything other than packets of folded interleaved cigarette rolling papers. As there appear to be no folded interleaved paper products on the market which are required in high volumes and of substantially the same size as cigarette papers, there is no obvious other product that can be manufactured on such apparatus without major modification. Moreover, such apparatuses tends not to be readily adapted for making packets of folded interleaved papers of other significantly different sized paper sheets, for example such as would be used in the manufacture of certain types of boxed tissue papers. Consequently, because the costs of the apparatuses cannot also be used to manufacture other products, this deters new potential manufacturers of conventional cigarette rolling papers from entering the market.

Pads of repositionable paper sheets are items of everyday use in most office environments.

Such products are, for example, sold by Minnesota Mining & Manufacturing Company, of St Paul, Minn., USA, under the trade mark “Post-It”. Such pads are sold in varying shapes, such as oblong-shaped pads and square-shaped pads, and in varying sizes, such as large-sized pads and small-sized pads. Each pad comprises i) a base sheet having a top side and a bottom side, and ii) a stack of paper sheets comprising an uppermost paper sheet, a lowermost paper sheet and a plurality of paper sheets between said uppermost and lowermost paper sheets, wherein each paper sheet of said stack has a top side facing away from said base sheet and a bottom side facing said base sheet, wherein each paper sheet of said stack is of substantially the same shape and size, wherein the lowermost paper sheet of said stack is adhered to the top side of said base sheet, and wherein at least a portion, usually a marginal edge, of the bottom side of each sheet of said stack located above said lowermost paper sheet is provided with a layer of pressure sensitive adhesive that adheres said sheet to the paper sheet immediately below it. Usually, the repositionable sheets are cut from papers having a weight of 80 gm⁻² or more.

U.S. Pat. No. 5,487,780 discloses a method and apparatus for applying pressure sensitive adhesive to a substrate, in which the adhesive is deposited on a transfer surface, such as a circulating transfer belt, dried, and subsequently transferred to a plurality of overlapping sheets of paper. The sheets are preferably coated with a primer or a low adhesion backsize, or both, prior to application of the adhesive. The sheets are then stacked to form master pads, which may then be guillotined into individual pads of repositionable paper sheets.

The advantages of the apparatus disclosed in U.S. Pat. No. 5,487,780 are described to be numerous. For example, the coating of supplied sheets of paper with pressure sensitive adhesive stripes is achieved in such a way that the sheets typically do not show any waviness, curling or other deviation from flatness. More particularly, the apparatus permits sheets of various sizes to be coated, limited only by the width of the transport mechanism that conveys the sheets through the apparatus. Thus, aside from the installation of suitable coating and transfer rollers, no other changes in machine parts are needed when the size of the sheets which are to be coated is changed.

EP-A-1509097 discloses a pad of cigarette rolling papers for making self-rolled cigarettes comprising i) a base sheet having a top side and a bottom side, and ii) a stack of cigarette papers comprising an uppermost paper, a lowermost paper and a plurality of papers between said uppermost and lowermost papers, wherein each cigarette paper in the stack is formed from cigarette paper having a weight of from 5 to 40 gm⁻², wherein each paper sheet of said stack has a top side facing away from said base sheet and a bottom side facing said base sheet, wherein each paper of said stack is of substantially the same shape and size, wherein the lowermost paper sheet of said stack is adhered to the top side of said base sheet, and wherein at least a portion of the bottom side of each paper of said stack located above said lowermost paper is provided with a layer of repositionable pressure sensitive adhesive that adheres said sheet to the paper sheet immediately below it.

WO-A-9610614 discloses an adhesive sheet material suitable for use on wet surfaces, in particular upon wet skin, comprising a porous backing made of fibers which absorb less than 4 percent by weight water and a water-insoluble, pressure sensitive adhesive which is discontinuously coated on one side of the backing to provide areas of the adhesive interspersed with areas of bare backing. Rotary screen printing is disclosed as being one suitable method for applying the adhesive to the backing.

Pads of cigarette papers according to EP-A-1509097 have been made wherein the repositionable pressure sensitive adhesive is provided on each sheet of cigarette paper as a continuous adhesive layer applied along a marginal edge on the bottom side of the sheet. An individual cigarette paper is obtained for use in rolling tobacco by lifting a free marginal edge and pulling the sheet in an upwards direction, away from the marginal edge that is adhered to the sheet below in the pad, so eventually separating the sheet from the pad. Once separated from the pad, the cigarette paper may be used to roll a cigarette as described in EP-A-1509097. Whilst separation of the individual cigarette papers from the pad is usually achieved successfully, the lifting and pulling action required to separate the individual sheets away from the pad can lead to the sheet being ripped at the marginal edge that is adhered to the sheet below it. This problem is particularly observed when the cigarette paper is pulled overzealously and/or the pad comprises only a few cigarette papers and is easily deformed by the pulling action, such as when most of the papers have been used. Thus, it is an object of the present invention to reduce the number of individual cigarette papers that may be spoilt as they are pulled away from the pad of cigarette papers.

### SUMMARY OF THE INVENTION

In accordance with a first aspect of the present invention there is provided a pad of rectangular cigarette rolling papers suitable for making self-rolled cigarettes comprising i) a base sheet having a top side and a bottom side, and ii) a stack of cigarette papers comprising an uppermost paper, a lowermost paper and a plurality of papers between said uppermost and lowermost papers, wherein each cigarette paper in the stack is formed from cigarette paper having a weight of from about 5 to about 40 gm⁻², wherein each paper sheet of said stack has a top side facing away from said base sheet and a bottom side facing said base sheet, wherein the lowermost paper sheet of said stack is adhered to the top side of said base sheet, and wherein the bottom side of each paper sheet of said stack located above said lowermost paper comprises a sticky area, located at or near to a marginal edge of the paper and extending the length of said marginal edge, which comprises a repositionable pressure sensitive adhesive coated onto the bottom side of the paper which adheres said sheet to the paper sheet immediately below it;

characterised in that said sticky area comprises a plurality of regions consisting of said repositionable pressure sensitive adhesive coated onto the bottom side of the paper and at least one region where the bottom side of the paper is not coated with pressure sensitive adhesive, wherein each region consisting of repositionable pressure sensitive adhesive coated on to the paper has no linear dimension greater than about 10 mm, preferably no greater than about 7 mm.

In accordance with a second aspect of the present invention there is provided a rectangular sheet of cigarette paper suitable for making a self-rolled cigarette, the sheet of cigarette rolling paper comprising i) a rectangular sheet of cigarette paper having a weight of from about 5 to about 40 gm⁻², a top side and a bottom side, wherein a portion of the bottom side is provided with ii) a sticky area, located at or near to a marginal edge of the cigarette paper and extending the length of said marginal edge, which sticky area comprises a repositionable pressure sensitive adhesive which is coated onto the bottom side of the paper and is suitable for adhering said portion of the bottom side to the top side of the cigarette paper when the paper is formed into a cigarette by rolling the paper around tobacco;

characterised in that said sticky area comprises a plurality of regions consisting of said repositionable pressure sensitive adhesive coated onto the bottom side of the paper and at least one region where the bottom side of the paper is not coated with pressure sensitive adhesive, wherein each region consisting of repositionable pressure sensitive adhesive coated on to the paper has no linear dimension greater than about 10 mm, preferably no greater than about 7 mm.

### BRIEF DESCRIPTION OF THE DRAWINGS

FIG. 1 is a plan view of a cigarette paper according to the invention.

FIG. 2 is a plan view of another embodiment of a cigarette paper according to the invention.

FIG. 3 is a plan view of another embodiment of a cigarette paper according to the invention.

FIG. 4 is a plan view of another embodiment of a cigarette paper according to the invention.

FIG. 5 is a plan view of another embodiment of a cigarette paper according to the invention.

FIG. 6 is a plan view of another embodiment of a cigarette paper according to the invention.

FIG. 7 is a plan view of another embodiment of a cigarette paper according to the invention.

FIG. 8 is a plan view of another embodiment of a cigarette paper according to the invention.

FIG. 9 is a plan view of another embodiment of a cigarette paper according to the invention.

FIG. 10 is a plan view of another embodiment of a cigarette paper according to the invention.

FIG. 11 is a plan view of another embodiment of a cigarette paper according to the invention.

### DETAILED DESCRIPTION OF THE INVENTION

In one aspect, the present invention provides a pad of rectangular cigarette rolling papers for making self-rolled cigarettes comprising i) a base sheet having a top side and a bottom side, and ii) a stack of cigarette rolling papers comprising an uppermost paper, a lowermost paper and a plurality of papers between said uppermost and lowermost papers, wherein each cigarette paper in the stack is formed from cigarette paper having a weight of from about 5 to about 40 gm⁻², wherein each paper sheet of said stack has a top side facing away from said base sheet and a bottom side facing said base sheet, wherein the lowermost paper sheet of said stack is adhered to the top side of said base sheet, and wherein the bottom side of each paper sheet of said stack located above said lowermost paper comprises a sticky area, located at or near to a marginal edge of the paper and extending the length of said marginal edge, which comprises a repositionable pressure sensitive adhesive coated onto the bottom side of the paper which adheres said sheet to the paper sheet immediately below it;

characterised in that said sticky area comprises a plurality of regions consisting of said repositionable pressure sensitive adhesive coated onto the bottom side of the paper and at least one region where the bottom side of the paper is not coated with pressure sensitive adhesive, wherein each region consisting of repositionable pressure sensitive adhesive coated on to the paper has no linear dimension greater than about 10 mm, preferably no greater than about 7 mm.

In another aspect, the present invention provides a rectangular cigarette rolling paper suitable for use in forming a self-rolled cigarette, the sheet of cigarette rolling paper comprising a) a rectangular sheet of cigarette paper having a weight of from about 5 to about 40 gm⁻², a top side and a bottom side, wherein a portion of the bottom side is provided with b) a sticky area, located at or near to a marginal edge of the cigarette paper and extending the length of said marginal edge, which sticky area comprises a repositionable pressure sensitive adhesive which is coated onto the bottom side of the paper and is suitable for adhering said portion of the bottom side to the top side of the cigarette paper when the paper is formed into a cigarette by rolling the paper around tobacco;

characterised in that said sticky area comprises a plurality of regions consisting of said repositionable pressure sensitive adhesive coated onto the bottom side of the paper and at least one region where the bottom side of the paper is not coated with pressure sensitive adhesive, wherein each region consisting of repositionable pressure sensitive adhesive coated on to the paper has no linear dimension greater than about 10 mm, preferably no greater than about 7 mm. A plurality of cigarette papers of this aspect of the invention are suitable for use in forming a stack of cigarette papers that constitute the stack of cigarette papers ii) in the first aspect.

The repositionable pressure sensitive adhesive is preferably made of non-toxic materials.

Each sheet of the cigarette papers that make up the cigarette rolling papers of the present invention is rectangular, preferably oblong. When the cigarette paper is oblong, it is preferable for the sticky area of pressure sensitive adhesive to extend the length of one of the two longer marginal edges of the paper. When the cigarette paper is oblong, it is preferable that it is no greater than about 5 cm wide, more preferably it is about 4 cm wide. The length of the oblong can vary depending upon the length of the cigarette to be rolled, but it is preferably no longer than about 12 cm. For example, when the cigarette paper is designed for rolling a king size cigarette, the cigarette paper is preferably about 10 cm long, and when the cigarette is designed for rolling a conventional length cigarette, the cigarette paper is preferably about 7 cm long.

The sticky area on the bottom side of each rolling paper sheet in the stack is preferably no wider than about 1 cm, more preferably no wider than about 0.5 cm.

When a sheet of cigarette rolling paper is one of the plurality of sheets of cigarette rolling paper that make up the stack, the sticky area on the bottom side of the paper sheet enables the sheet to adhere to the sheet in the stack immediately below it. When a cigarette rolling paper is separated from the pad and used to form a self-rolled cigarette, the sticky area provides an adhesive seal running the length of the cigarette which prevents the cigarette from unrolling, as described EP-A-1509097.

The sticky area may be made by coating the repositionable pressure sensitive adhesive onto the cigarette paper. Preferably, the repositionable pressure sensitive adhesive is coated onto the paper by rotary screen printing, such as disclosed in WO-A-9610614. Each region consisting of repositionable pressure sensitive adhesive coated on to the paper has no linear dimension greater than about 10 mm, preferably no greater than about 7 mm. Each region consisting of repositionable pressure sensitive adhesive coated on to the paper has no linear dimension greater than about 10 mm, preferably no greater than about 7 mm: there is no other restriction upon the size or shape of said regions. A linear dimension is a length measured in one dimension only. Preferably, the regions are separate discrete regions.

### Examples of Shapes of Possible Regions Include:

| | |
|---|---|
| 1. | \ / \ / \ / \ / \ / \ / \ / \ / \ / \ / \ / \ / \ / \ / \ / \ / \ / |
| 2. | / : / : / |
| 3. | \ \ \ \ \ \ \ |
| 4. | / / / / / / / |
| 5. | / : \ : / : \ |
| 6. | [symbol] |
| 7. | [symbol] |
| 8. | [symbol] [symbol] [symbol] [symbol] [symbol] [symbol] [symbol] [symbol] [symbol] [symbol] [symbol] |
| 9. | ≠ ≠ ≠ ≠ ≠ ≠ ≠ |
| 10. | [symbol] |
| 11. | [symbol] |
| 12. | [symbol] [symbol] [symbol] [symbol] [symbol] [symbol] [symbol] |
| 13. | [symbol] [symbol] [symbol] [symbol] [symbol] [symbol] [symbol] |
| 14. | x x x x x |

In one preferred embodiment, the adhesive is coated onto the paper within the sticky area as a plurality of adhesive dots, wherein each dot has a maximum linear dimension no greater than about 0.5 mm, more preferably no greater than about 0.3 mm, though it will be appreciated that the maximum dimension of the adhesive dots may be much smaller than this, for example the maximum dimension may be as small as about 30 microns. Preferably, the adhesive dots have a maximum dimension in the range of from about 30 to about 500 microns. The adhesive dots may be in the form of an array, where it is preferred that each dot is separated from another dot by a distance not exceeding the maximum dimension of the dot.

The repositionable pressure sensitive adhesive may be coated to the cigarette papers in such a manner so as to provide a pattern of adhesive on the paper before the papers are collated and assembled into a stack. The pattern may be applied such that it is visible from the opposite side of the paper on which it is applied. The pattern may be an advertisement, picture, slogan, logo or trademark.

In one embodiment, a thin continuous line of pressure sensitive adhesive may be coated on to the bottom side of the cigarette paper so as to define a border between the sticky area and a portion of the cigarette paper that is not sticky. In the same or in another embodiment, within the sticky area one or more thin continuous lines of pressure sensitive adhesive may be coated on to the bottom side of the cigarette paper so as to define one or more borders between a plurality of regions within the sticky area that are not coated with pressure sensitive adhesive. In these embodiments, the line of pressure sensitive adhesive preferably extends the length of the sticky area and is preferably no more than about 1 mm wide, more preferably about 30-500 microns wide. Preferably, however, the sticky area is free of such bordering lines.

The sticky area exists at the marginal edge of each paper. To assist separation of the cigarette rolling papers during use, it is preferred that the sticky area is off-set a distance, e.g. from about 0.25 to about 10 mm, preferably from about 1 to about 5 mm, from the very edge of the paper. By off-setting the sticky area a short distance from the edge of the paper, it becomes possible for a user to easily lift the top paper, with the use of fingers, from that edge and separate the paper from the remaining stack of papers.

The sticky area may be provided at the same marginal edge of the cigarette rolling papers in the stack, so as to provide a pad of cigarette rolling papers held together in the form of a book with a single adhesive spine. Alternatively, the sticky area may be provided on different marginal edges of adjacent papers in the stack. For example, the adhesive may be applied on opposite marginal edges of successive papers, so as to provide a pad of cigarette rolling papers held together in the form of a concertina i.e. [symbol] .

Preferably the pads are made of sheets of cigarette rolling papers that are substantially the same size and weight as a conventional cigarette rolling paper. Cigarette papers are typically water absorbent, and when exposed to water will absorb more than 4 wt %, based on the weight of the dry paper. Preferably, the cigarette rolling papers are made from cigarette paper having a weight of from about 10 to about 25 gm⁻².

The present invention enables a reduction in the number of cigarette rolling papers which are spoilt as they are pulled away from the stack of papers. Without wishing to be bound by theory, it is believed that by providing the repositionable pressure sensitive adhesive in the sticky area as a plurality of small regions, as opposed to a continuous layer as provided in the prior art, the peel strength of the adhesive is reduced so enabling the papers to be pulled off the pad more easily. Although peel strength is reduced, tack and shear strength is not substantially affected, so the structural integrity of the pad is not materially reduced.

In addition to the above surprising benefits, because the sticky area now includes regions not coated by adhesive, the pads of the invention require less adhesive to produce them than the prior art pads.

Persons skilled in the art of making pads of paper will readily be able to manufacture the pads of the present invention.

Each sheet of cigarette paper in the pad may be provided with a release coating on its top side that contacts the sticky area on the paper above it, so as to assist in the separation of the papers from the pad, as is well known in the art. However, it is preferable that each sheet of cigarette paper is not provided with a release coating, as this reduces the number of procedures required to manufacture the papers.

The cigarette rolling papers may have a decorative finish. Suitable decorative finishes include one or more decorative images selected from the group consisting of patterns, scenic views, portraits, photographic images, and cartoon characters, such as typically found on conventional wrapping papers.

Decorative finishes may also be selected from one or more of advertisements, company names, slogans, trademarks and logos, price lists, product information, maps, route directions, and time tables. The inks used to make the images on the sheets of paper are preferably non-toxic.

The cigarette rolling papers may be made from flavoured and/or scented cigarette papers, such as chocolate, coffee, mint or banana. The flavourings or scents used to make such papers are preferably non-toxic.

In another embodiment, the flavourings and/or scents may be carried in the adhesive. A person skilled in the relevant art can readily formulate such flavourings and/or scents into the adhesives.

When a cigarette rolling paper of the present invention is formed into a cigarette by rolling the paper around tobacco, the repositionable nature of the pressure sensitive adhesive is such that it adheres the portion of the bottom side to the top side of the paper without the need to introduce moisture to the adhesive, such as by licking.

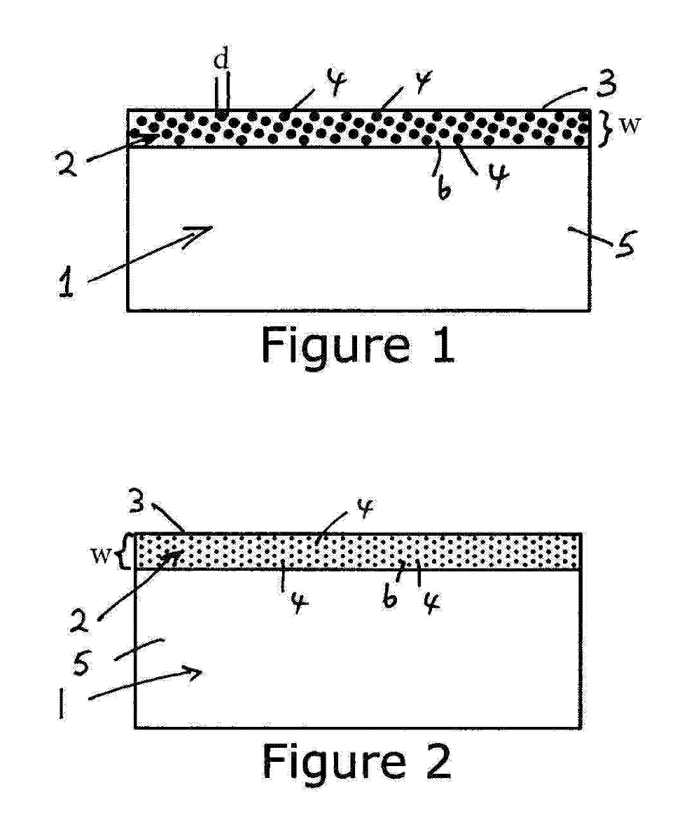

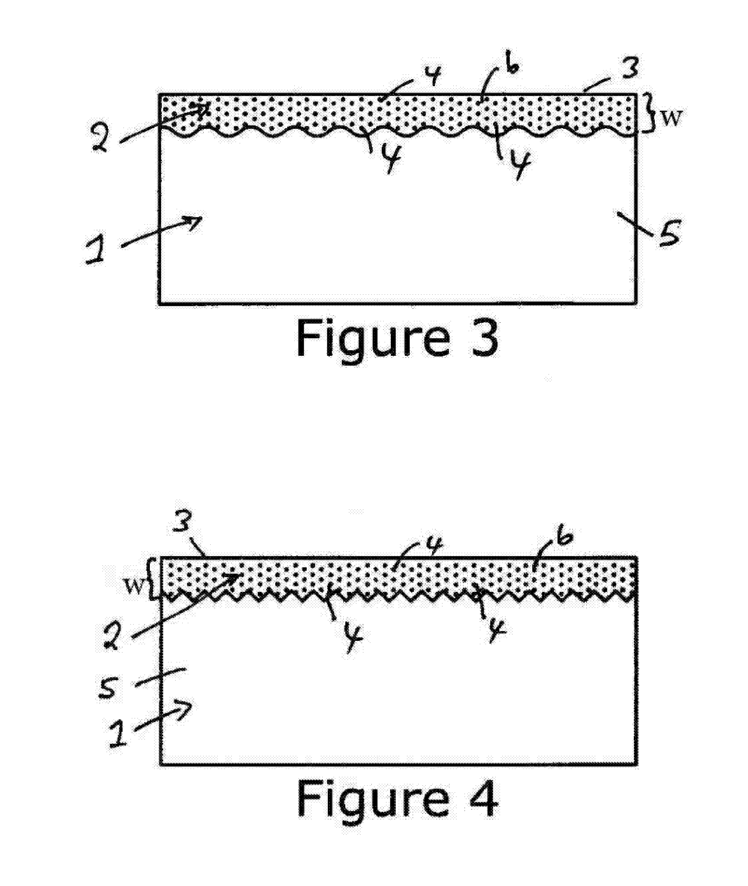

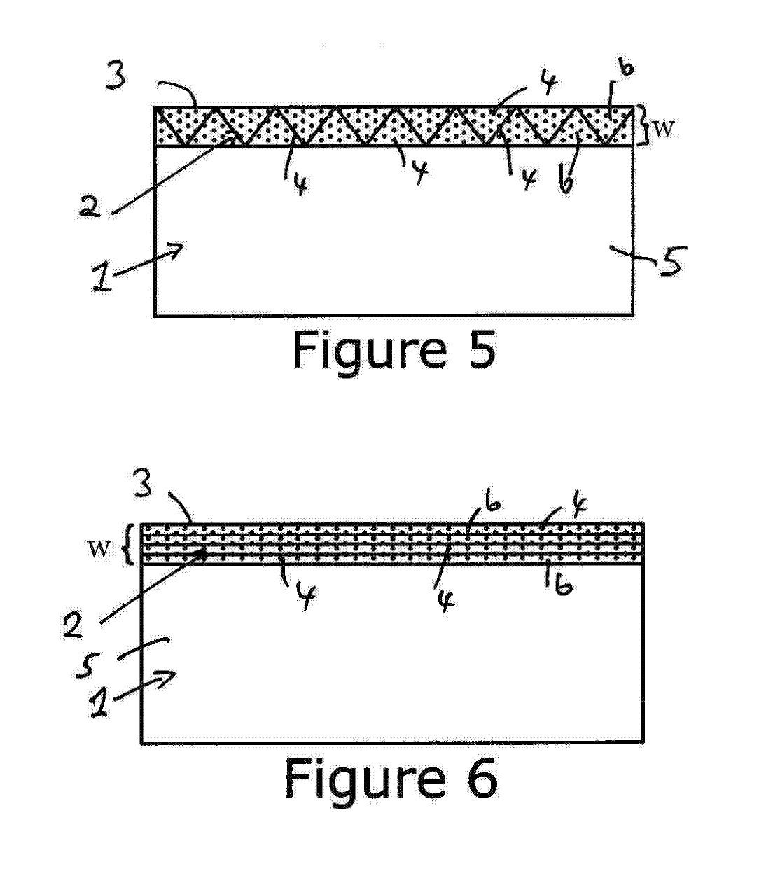

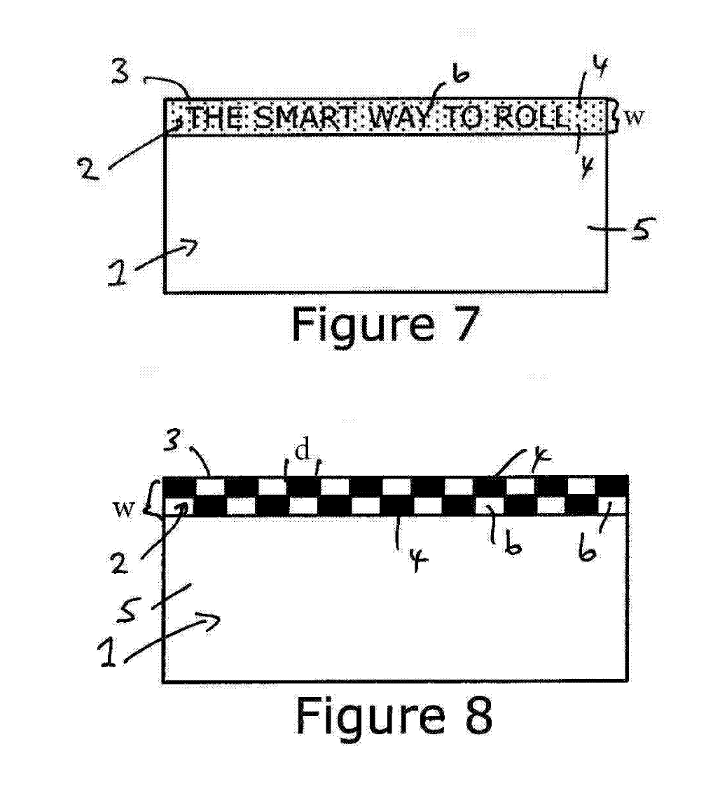

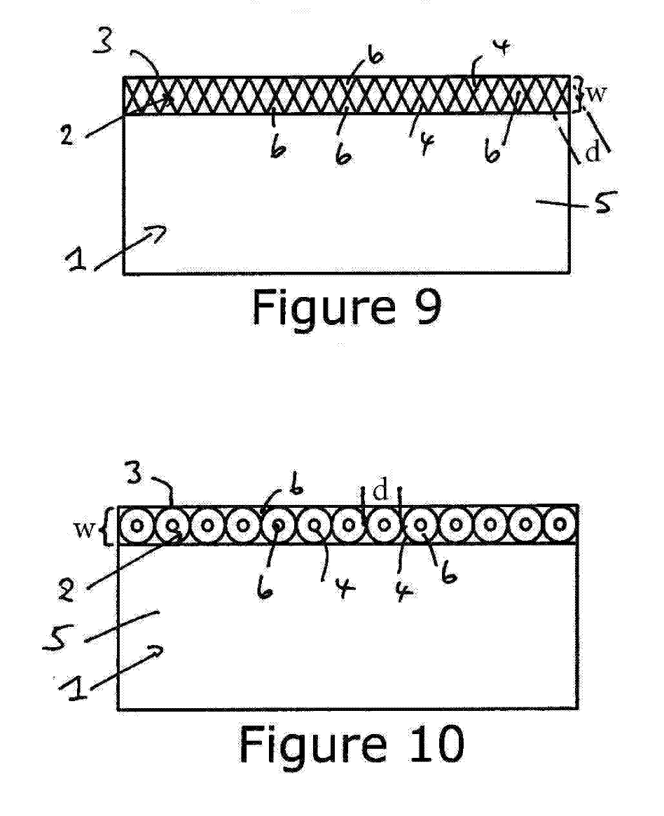

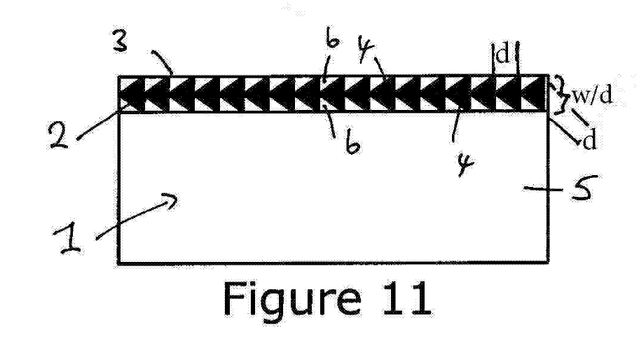

Various embodiments of cigarette rolling papers that may be used to make pads of cigarette rolling papers are illustrated in FIGS. 1-11 (these are plan views of the bottom side of the cigarette rolling papers).

FIGS. 1 to 11 are plan views of the bottom sides of various embodiments of cigarette rolling papers according to the present invention. Each cigarette rolling paper 1 is provided with a sticky area 2 that extends the length of a marginal edge 3 and has a width w. The sticky area 2 comprises a plurality of regions 4 that consist of a repositionable pressure sensitive adhesive that has been coated on to bottom surface of a rectangular cigarette paper 5 and at least one region 6 where the bottom side of the cigarette paper 5 is not coated with repositionable pressure sensitive adhesive. The regions 4 that consist of repositionable pressure sensitive adhesive coated on to the bottom surface of the cigarette paper have no linear dimension d that is more than 10 mm.

1. A pad of rectangular cigarette rolling papers for making self-rolled cigarettes comprising i) a base sheet having a top side and a bottom side, and ii) a stack of cigarette papers comprising an uppermost paper, a lowermost paper and a plurality of papers between said uppermost and lowermost papers, wherein each cigarette paper in the stack is formed from cigarette paper having a weight of from 5 to 40 gm⁻², wherein each paper sheet of said stack has a top side facing away from said base sheet and a bottom side facing said base sheet, wherein the lowermost paper sheet of said stack is adhered to the top side of said base sheet, and wherein the bottom side of each paper sheet of said stack located above said lowermost paper comprises a sticky area, located at or near to a marginal edge of the paper and extending the length of said marginal edge, which comprises a repositionable pressure sensitive adhesive coated onto the bottom side of the paper which adheres said sheet to the paper sheet immediately below it;
characterised in that said sticky area comprises of a plurality of regions consisting of said repositionable pressure sensitive adhesive coated onto the bottom side of the paper and at least one region where the bottom side of the paper is not coated with pressure sensitive adhesive, wherein each region consisting of repositionable pressure sensitive adhesive coated on to the paper has no linear dimension greater than 10 mm, preferably no greater than 7 mm.

2. A pad of cigarette rolling papers as claimed in claim 1, wherein the sticky area on the bottom side of each paper sheet is no wider than 1 cm, preferably no wider than 0.5 cm.

3. A pad of cigarette rolling papers as claimed in claim 1 or claim 2, wherein the sticky area comprises a plurality of adhesive dots.

4. A pad of cigarette rolling papers as claimed in claim 3, wherein each adhesive dot within the sticky area has a maximum linear dimension no greater than about 0.5 mm, preferably no greater than about 0.3 mm.

5. A pad of cigarette papers as claimed in claim 4, wherein each adhesive dot within the sticky area has a maximum linear dimension in the range 30-500 microns.

6. A pad of cigarette rolling papers as claimed in claim 4, wherein each of the adhesive dots is separated from another dot by a distance not exceeding the maximum dimension of the dot.

7. A pad of cigarette rolling papers as claimed in any one of the preceding claims, wherein the sticky area is made by rotary screen printing a repositionable pressure sensitive adhesive on to cigarette paper.

8. A pad of cigarette papers as claimed in any one of the preceding claims, wherein the top side of each cigarette paper in the stack is not provided with a release coating.

9. A rectangular cigarette rolling paper suitable for use in forming a self-rolled cigarette, the sheet of cigarette rolling paper comprising a) a rectangular sheet of cigarette paper having a weight of from about 5 to about 40 gm⁻², a top side and a bottom side, wherein a portion of the bottom side is provided with b) a sticky area, located at or near to a marginal edge of the cigarette paper and extending the length of said marginal edge, which sticky area comprises a repositionable pressure sensitive adhesive which is coated onto the bottom side of the paper and is suitable for adhering said portion of the bottom side to the top side of the cigarette paper when the paper is formed into a cigarette by rolling the paper around tobacco;
characterised in that said sticky area comprises a plurality of regions consisting of said repositionable pressure sensitive adhesive coated onto the bottom side of the paper and at least one region where the bottom side of the paper is not coated with pressure sensitive adhesive, wherein each region consisting of repositionable pressure sensitive adhesive coated on to the paper has no linear dimension greater than about 10 mm, preferably no greater than 7 mm.

10. A cigarette rolling paper as claimed in claim 9, wherein the sticky area on the bottom side of the paper is no wider than 1 cm, preferably no wider than 0.5 cm.

11. A cigarette rolling paper as claimed in claim 9 or claim 10, wherein the sticky area comprises a plurality of adhesive dots.

12. A cigarette rolling papers as claimed in claim 11, wherein each adhesive dot within the sticky area has a maximum linear dimension no greater than about 0.5 mm, preferably no greater than about 0.3 mm.

13. A cigarette rolling paper as claimed in claim 12, wherein each adhesive dot within the sticky area has a maximum linear dimension in the range 30-500 microns.

14. A cigarette rolling paper as claimed in any one of claims 12 to 13, wherein each of the adhesive dots is separated from another dot by a distance not exceeding the maximum dimension of the dot.

15. A cigarette rolling paper as claimed in any one claims 9 to 14, wherein the top side of each cigarette paper is not provided with a release coating.
